(19) United States
(12) Patent Application Publication
(10) Pub. No.: US 2023/0268483 A1
(43) Pub. Date: Aug. 24, 2023

(54) ORGANIC SUBLIMABLE MATERIAL-ASSISTED ELECTRODES

(71) Applicants: Regents of the University of Minnesota, Minneapolis, MN (US); Board of Regents, The University of Texas System, Austin, TX (US)

(72) Inventors: Christopher John Ellison, Eden Prairie, MN (US); Charles Buddie Mullins, West Lake Hills, TX (US); Samantha Nicole Lauro, Austin, TX (US); Joshua Paul Pender, Glendale, WI (US); Han Xiao, Minneapolis, MN (US); Jason Alexander Weeks, JR., Austin, TX (US); James Norman Burrow, JR., Austin, TX (US)

(21) Appl. No.: 18/112,130

(22) Filed: Feb. 21, 2023

Related U.S. Application Data
(60) Provisional application No. 63/311,689, filed on Feb. 18, 2022.

(51) Int. Cl. H01M 4/1391; H01M 10/0525; H01M 4/131; H01M 4/04; H01M 4/62; H01M 4/485; H01M 4/505; H01M 4/525; H01M 4/36; H01B 1/18

(52) U.S. Cl. CPC H01M 4/1391; H01M 10/0525; H01M 4/131; H01M 4/0433; H01M 4/0485; H01M 4/0404; H01M 4/622; H01M 4/485; H01M 4/505; H01M 4/525; H01M 4/366; H01M 4/623; H01B 1/18

(57) ABSTRACT

A method of making a porous film includes disposing a slurry on a substrate, solidifying the slurry to yield a film on the substrate, and subliming the organic sublimable material to yield the porous film on the substrate. The slurry includes an electrochemically active material, an electrically conductive material, and a binder dispersed in an organic sublimable material. The electrochemically active material and the electrically conductive material are different.

A slurry includes a solid component including an electrochemically active material, an electrically conductive material, and a binder; and a liquid component including an organic sublimable material, wherein the electrochemically active material and the electrically conductive material are different, and the solid component is dispersed in the liquid component.

### RELATED APPLICATION

This application claims the benefit under 35 U.S.C. § 119(e) of U.S. provisional application No. 63/311,689, filed Feb. 18, 2022, which is incorporated by reference herein in its entirety.

### STATEMENT OF GOVERNMENT SUPPORT

This invention was made with government support under IIP1940986 awarded by the National Science Foundation. The government has certain rights in the invention.

### TECHNICAL FIELD

This invention relates to electrodes for electrochemical devices and fabrication thereof.

### BACKGROUND

Electrochemical devices are ubiquitous. Rechargeable batteries, such as lithium ion batteries (LIBs), are used as a source of portable energy storage in consumer products such as laptops and cellphones. Present generation LIBs utilize copper or aluminum foil substrates for the anode and cathode current collector (CC), respectively, which act as conductive and mechanical supports for the LIB films. The metal foils used in LIBs comprise approximately 20 wt % and 15 wt % of the anode and cathode, respectively, but do not play a role in the electrochemical activity of the device.

### SUMMARY

This disclosure describes organic sublimable material-assisted electrodes and methods of fabricating electrodes. For example, free-standing electrodes (FSEs) and a fabrication system that eliminates the need for metal-foil current collectors (CCs) in electrochemical systems. This electrode production platform can be implemented both into industrially-established electrode processing lines and with newer forms of additive manufacturing such as 3D printing. This scalable fabrication process allows for simultaneous control of electrode thickness, porosity, and conductivity by manipulating slurry composition and casting protocol.

FSEs provide increases in the gravimetric and volumetric energy densities of electrochemical devices by eliminating both dead weight and underutilized space from traditional CCs without detrimentally compromising cost, conductivity, or rate capability.

Provided herein is a method of making a porous film. The method includes disposing a slurry on a substrate, wherein the slurry includes an electrochemically active material, an electrically conductive material, and a binder dispersed in an organic sublimable material, wherein the electrochemically active material and the electrically conductive material are different; solidifying the slurry to yield a film on the substrate; and subliming the organic sublimable material to yield the porous film on the substrate.

In some embodiments, the method further includes reducing a thickness of the porous film.

In some embodiments, during disposing, a temperature of the slurry exceeds a melting point of the organic sublimable material.

In some embodiments, solidifying the slurry includes cooling the slurry to a temperature below a melting point of the organic sublimable material.

In some embodiments, the method further includes separating the porous film and the substrate.

In some embodiments, disposing comprises slurry casting, mold casting, or additive manufacturing.

Also provided herein is a slurry including a solid component including an electrochemically active material, an electrically conductive material, and a binder; and a liquid component including an organic sublimable material; wherein the electrochemically active material and the electrically conductive material are different, and the solid component is dispersed in the liquid component.

In some embodiments, the electrochemically active material includes one or more of a lithium iron phosphate, a lithium titanium oxide, a nickel cobalt manganese oxide, a lithium cobalt oxide, and a sodium manganese oxide.

In some embodiments, the electrochemically active material includes one or more of a metal alloy, a metal oxide, a chalcogenide, silicon, tin, and an electron-conducting carbon based material; wherein the electron-conducting carbon based material includes one or more of graphene, graphite, carbon nanotubes, and porous carbons.

In some embodiments, the electrically conductive material includes one or more of carbon black, carbon nanotubes, graphene oxide, graphene, reduced graphene oxide, and metal nanostructures.

In some embodiments, the binder includes a thermoplastic polymer; wherein the thermoplastic polymer includes one or more of a styrene-ethylene-butylene-styrene copolymer, a sodium carboxy methyl cellulose, a styrene butyl rubber, a polyvinylidene fluoride, and a polyolefin.

In some embodiments, the organic sublimable material comprises one or more of a terpene, naphthalene, anthracene, salicylic acid, benzophenone, pyrene, 1,6-diaminohexane, hexamethylenetetramine; adamantane, 2,4,6-triamino-1,3,5-triazine, and phthalic anhydride. In some embodiments, the terpene includes one or more of camphene, menthol, borneol, camphor, and pinene.

In some embodiments, a weight ratio of the liquid component to the solid component is in a range of about 2:1 to about 4:1.

In some embodiments, the solid component includes about 70 wt % to about 90 wt % of the electrochemically active material, about 5 wt % to about 20 wt % of the electrically conductive material, and about 1 wt % to about 10 wt % of the binder.

In some embodiments, a temperature of the slurry exceeds a melting point of the organic sublimable material.

In some embodiments, the slurry is free of N-methyl-2-pyrrolidone.

Also provided herein is an electrode including the porous film disclosed herein.

In some embodiments, the porous film is separated from the substrate; or the electrode includes a metal current collector in contact with a surface of the electrode.

Also provided herein is a lithium-ion battery including the electrode disclosed herein.

The details of one or more embodiments of the subject matter of this disclosure are set forth in the accompanying drawing and the description. Other features, aspects, and advantages of the subject matter will become apparent from the description, the drawing, and the claims.

### BRIEF DESCRIPTION OF DRAWINGS

FIG. 1 illustrates an example synthetic process of organic sublimable material-assisted fabrication of free-standing electrodes.

### DETAILED DESCRIPTION

This disclosure describes an organic sublimable material-based system, for example a camphene-based system, for fabricating electrodes. In some embodiments, the electrodes are free-standing electrodes (FSEs).

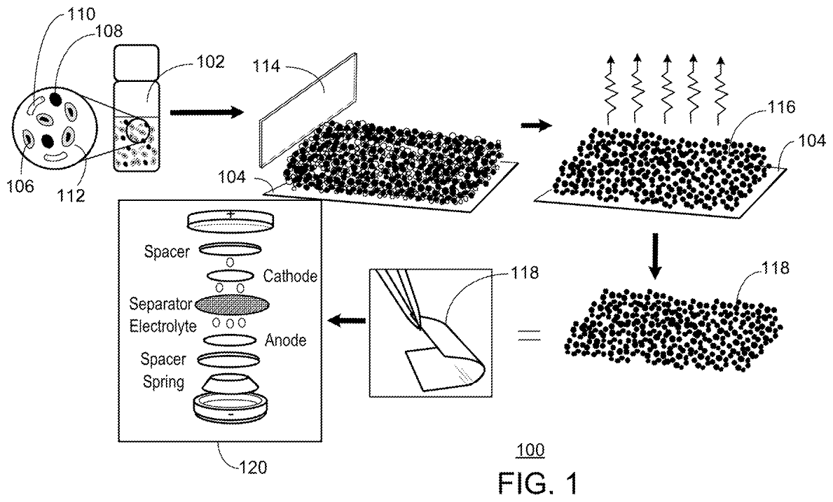

FIG. 1 depicts an example method 100 of making a porous film. The method includes disposing a slurry 102 on a substrate 104. The slurry 102 includes an electrochemically active material 106, an electrically conductive material 108, and a binder 110 dispersed in an organic sublimable material 112, wherein the electrochemically active material 106 and the electrically conductive material 108 are different. In some embodiments, the slurry is formed by mixing the electrochemically active material 106, electrically conductive material 108, binder 110, and organic sublimable material 112 at an elevated temperature, for example, 60° C.

In some embodiments, disposing comprises slurry casting, mold casting, or additive manufacturing. In some embodiments, the slurry 102 is disposed on the substrate 104 by slurry casting with a doctor blade 114 at an elevated temperature, for example, 70° C.

In some embodiments, during the disposing, a temperature of the slurry exceeds a melting point of the organic sublimable material 112.

The method further includes solidifying the slurry 102 to yield a film on the substrate 104, and subliming the organic sublimable material to yield the porous film 116 on the substrate 104. In some embodiments, the solidifying the slurry 102 comprises cooling the slurry to a temperature below a melting point of the organic sublimable material.

In some embodiments, the method further comprises reducing a thickness of the porous film 114. For example, the reducing the thickness of the porous film 116 comprises compressing the porous film. In some embodiments, reducing a thickness of the porous film 114 alters the porosity of the porous film 114.

In some embodiments, the method further comprises separating the porous film 116 and the substrate 104 to provide a free standing electrode 118. In some embodiments, separating the porous film 116 and the substrate 104 comprises delaminating the porous film from the substrate.

In some embodiments, the porous film 116 is not removed from the substrate 104. For example, the substrate 104 comprises a conductive material, such as a metal foil, that can be used as a current collector in a lithium-ion battery.

In some embodiments, a thickness of the porous film 116 is in a range of 0.05 mm and 2 mm.

In some embodiments, the electrochemically active material 106 comprises one or more of a metal alloy, a metal oxide, a chalcogenide, silicon, tin, and an electron-conducting carbon based material. In some embodiments, the electron-conducting carbon based material comprises one or more of graphene, graphite, carbon nanotubes, and porous carbons.

In some embodiments, the electrochemically active material 106 comprises one or more of a lithium iron phosphate, a lithium titanium oxide, a nickel cobalt manganese oxide, a lithium cobalt oxide, and a sodium manganese oxide.

In some embodiments, the electrically conductive material 108 material comprises one or more of carbon black, carbon nanotubes, graphene oxide, graphene, reduced graphene oxide, and metal nanostructures. In some embodiments, the conductive material 108 comprises carbon black, for example, SuperP.

In some embodiments, the binder 110 comprises a thermoplastic polymer. In some embodiments, the thermoplastic polymer comprises one or more of a styrene-ethylene-butylene-styrene copolymer, a sodium carboxy methyl cellulose, a styrene butyl rubber, a polyvinylidene fluoride, and a polyolefin. For example, the binder 110 comprises a styrene-ethylene-butylene-styrene copolymer.

In some embodiments, the organic sublimable material 112 comprises one or more of a terpene, naphthalene, anthracene, salicylic acid, benzophenone, pyrene, 1,6-diaminohexane, hexamethylenetetramine; adamantane, 2,4,6-triamino-1,3,5-triazine, and phthalic anhydride. In some embodiments, the organic sublimable material 112 comprises a terpene. In some embodiments, the terpene comprises one or more of camphene, menthol, borneol, camphor, and pinene. For example, the organic sublimable material 112 comprises camphene.

In some embodiments, the substrate 104 comprises fluoropolymer, metal foil, or silicone. In some embodiments, the fluoropolymer comprises polytetrafluoroethylene. In some embodiments, the substrate 104 comprises a metal foil.

Also provided herein is a slurry 102 (FIG. 1) comprising a solid component and a liquid component. The solid component comprises an electrochemically active material 106, an electrically conductive material 108, and a binder 110. The liquid component comprises an organic sublimable material 112. The electrochemically active material 106 and the electrically conductive material 108 are different. The solid component is dispersed in the liquid component.

In some embodiments, a weight ratio of the liquid component to the solid component is in a range of about 2:1 to about 4:1.

In some embodiments, the solid component comprises about 70 wt % to about 90 wt % of the electrochemically active material; about 5 wt % to about 20 wt % of the electrically conductive material; and about 1 wt % to about 10 wt % of the binder.

In some embodiments, a temperature of the slurry 102 exceeds a melting point of the organic sublimable material 112.

In some embodiments, the slurry 102 if free of N-methyl-2-pyrrolidone.

Also provided herein is an electrode including an electrochemically active material 106, an electrically conductive material 108, and a binder 110, wherein the electrochemically active material 106 and the electrically conductive material 108 are different, and the electrode is porous and flexible. For example, the electrode is the free standing electrode 118 depicted in FIG. 1.

In some embodiments, the electrode is free of a substrate. In some embodiments, the electrode is free of a metal substrate.

In some embodiments, a thickness of the electrode is in a range of 0.05 mm and 2 mm.

In some embodiments, the electrode comprises about 70 wt % to about 90 wt % of the electrochemically active material 106, about 5 wt % to about 20 wt % of the electrically conductive material 108, and about 1 wt % to about 10 wt % of the binder.

In some embodiments, the electrode further comprises a metal current collector in contact with a surface of the electrode.

In some embodiments, the electrode has a porosity in the range of about 50% porosity to about 85% porosity, or about 40% to about 75% porosity. The porosity can be calculated by the mass and dimensional measurements of the electrode combined with the known composition and mass density of materials used to make the electrode. The porosity can also be measured with porosimetry methods, for example, mercury intrusion porosimetry.

Also provided is an electrode comprising the porous film described herein. In some embodiments, the porous film is separated from the substrate, or the electrode comprises a metal current collector in contact with a surface of the electrode. In some embodiments, the porous film is separated from the substrate such that the electrode is free of a substrate. In some embodiments, the porous film is on a metal foil substrate, wherein the metal foil substrate is a metal current collector.

Also provided herein is a lithium-ion battery including the electrode described herein. For example, lithium-ion battery coin cell 120 depicted in FIG. 1. For demonstration as an effective electrode architecture, these FSEs are directly used in lithium-ion battery cells. In some embodiments, the lithium-ion battery is a pouch cell or a jelly roll cell.

Camphene, an inexpensive and readily available terpene which has a modest melting point (52° C.), high vapor pressure (3.4 mmHg @ 25° C.), and dendritic crystallization morphology, can solubilize/disperse various polymers and particles, as well as poly(styrene-block-ethylene/butylene-block-styrene) (SEBS) block copolymers. Due at least in part to these physical properties, when employed as a solvent for slurry casting electrode materials in the liquid state, camphene crystallites can act as a template to induce a percolating conductive network of electrode components upon its solidification. Direct removal of the camphene by sublimation via room temperature vacuum drying and subsequent delamination from the casting substrate results in the production of a porous, free-standing, and flexible composite electrode.

As this FSE manufacturing method is compatible with current industrial fabrication processes (i.e., roll-to-roll processing), the camphene based solvent system offers multiple potential benefits for LIB manufacturing. First, camphene acts as a less-toxic solvent alternative to N-methyl-2-pyrrolidone (NMP) in traditional LIB production. NMP is currently the preferred solvent for LIB electrode casting; however, NMP is toxic to humans. Second, the crystallite-templating nature of the camphene solvent allows for the fabrication of porous FSEs and the elimination of metal foil-based current collectors (CCs). Elimination of these CCs reduces material cost and eliminates ‘inactive’ material weight within electrochemical devices, thereby increasing overall energy density. Third, camphene-based casting allows for a material-agnostic platform for tailorable electrode production that will likely be compatible with future device chemistries.

The described fabrication platform generates mechanically robust and flexible electrodes. For demonstration in LIBs as one potential application area, FSEs were fabricated using a range of different active materials such as lithium iron phosphate (LiFePO₄, LFP), lithium titanium oxide (Li₄Ti₅O₁₂, LTO), nickel cobalt manganese oxide (Ni_{0.8}Co_{0.1}Mn_{0.1}O₂, NCM811), and lithium cobalt oxide (LiCoO₂, LCO). As used herein, “active material” generally refers to an electrochemically active material (i.e., a material that participates in an electrochemical redox reaction at an electrode enabling the interconversion of electrical and chemical energy). Performance testing of these composites for potential application in LIBs illustrates their properties and energy storage capabilities; for example, LFP based electrodes demonstrated stable electrochemical (de-)lithiation for over 1000 cycles with only small capacity losses (16 mAh/g). These camphene-assisted FSEs demonstrate competitive to superior electrochemical capabilities when compared to counterparts cast on metal foil, and the elimination of CCs allows for significant improvements to the cell-level energy densities of these devices. While achieving near-equivalent volumetric capacity to foil cast counterparts, the camphene-assisted fabrication route allowed the production of thick electroactive films to enhance the areal capacity 2 times and the electrode gravimetric capacity by 50% as compared to conventional slurry casting.

Removal of Current Collectors. Camphene-assisted fabrication allows for the formation of FSEs, thus eliminating the need for a metal foil CC. These CCs are inactive in the electrochemistry of the cell. Therefore, their removal enhances the overall energy density of the electrochemical cells by reducing dead weight and volume.

Tunable Porosity. Camphene acts as a soft-templating agent by promoting the formation of void space upon removal and, as such, allows manipulation of electrode morphology by altering the ratio of active mass to camphene mass (AM:CM). Mass transport limitations are one of the major bottlenecks in many electrochemical devices, such as the (dis)charging rate and power density of state-of-the-art LIBs. Due to rapid depletion of electroactive species in the electrolyte near the electrode surface, the maximum effective thickness of an industrial LIB electrode is ˜200 μm, regardless of the intrinsic kinetics of an electrochemical reaction. Tuning the porosity (and tortuosity) of the FSE allows enhanced electrolyte penetration and lithiation site accessibility, thus mitigating these diffusive limitations and unlocking the utilization of thicker electrodes with significantly increased active material mass loadings. Because of this tunable porosity, energy densities in LIBs achieved with this camphene-assisted FSE system exceed those attainable with current electrode fabrication processes.

Tunable Thickness. In addition to tunable porosity, this electrode manufacturing method allows for fabrication of electrodes with varying thicknesses to enable enhanced aerial capacities and energy densities. For example, electrodes have been manufactured up to 2 mm in thickness with an aerial mass loading of approximately 40 mg/cm² through this method while maintaining effective performance. Traditional foil-cast electrodes are typically not able to be made above 200 μm in thickness, due to both mass transport limitations and delamination issues. This FSE system provides a pathway to make thick, high loading electrodes. Thicker electrodes with similar or increased effective volumetric energy density (mAh/cm³) enable faster throughput in manufacturing of electrochemical devices; by decreasing the number of electrode layers required, the time needed to cast a given length of electrode in a roll-to-roll process for a given energy density also decreases.

Thick Electrodes by Stacking. In addition to tunable thickness of individual films, this FSE system allows for thick electrodes to be made by stacking thinner electrode films on top of one another. This alternative manufacturing route can lower manufacturing costs by requiring a manufacturing line to only produce a single thickness electrode film. These thin films can be used to fabricate electrodes of different thicknesses and aerial mass loadings by stacking and calendaring the thin electrode films together, allowing multiple electrode thickness options from a single film casting. This is not typically possible for foil-cast electrode films, because direct stacking of these films would block access to the active material.

Improvements to Energy Density. Fabrication of thicker FSEs due to the benefits of tunable electrode porosities enables electrodes with higher gravimetric and areal mass loadings. Thus, at a given cell capacity, FSEs fabricated from a camphene manufacturing process can be as much as 50% lighter and 10% thinner as compared to state-of-the-art LIB manufacturing processes via removal of CCs. Lighter and/or thinner electrode assemblies allow for cost reductions by packing more active material per unit weight or volume. Alternatively, higher areal mass loading (i.e., thicker) electrodes possess increased power density (W/cm²) to unlock certain applications that traditional LIBs fail to address (e.g., power tools, rail transport, freight transport, and aerospace applications).

Elimination of NMP Solvent System. Current electrode fabrication processes use NMP as a solvent. In 2020, the EPA found the use of NMP as an unreasonable risk for many industrial settings in the amended TSCA act (EPA-HQ-OPPT-2019-0236). Current regulations require extensive ventilation and energy-consuming cold trap reclamation systems in order to employ NMP for battery fabrication. The disclosed camphene-assisted method provides a cost-competitive and less toxic alternative. Furthermore, the low vapor pressure of camphene allows reclamation at room temperature, reducing the energy cost of production. This also enables safer working conditions for manufacturing line workers.

Recyclability. Industrial recyclability includes at least three steps: 1) pack/cell disassembly, 2) physical separation, and 3) chemical separation. Implementation of this FSE system eliminates the need to separate the electrode materials from a substrate or metal foil CC, as electrodes can be directly digested once removed from the cell, leading to lower recycling costs.

Production Versatility. While the described system demonstrates compatibility with current electrode manufacturing methods and cell chemistries, this formulation is also compatible with mold-casting, thermoforming, and additive manufacturing (3-D printing) production methods. This enables creation of custom shaped or free-form electrodes for specialty applications which may require more control over electrode design/shape than current conventional methods provide. Additive manufacturing is advantageous at least in part because it eliminates waste of unused material (e.g., costly electrochemically active material). Additive manufacturing is the selective deposition of material, rather than, for example, cutting out from full sheets of slurry cast material. The tunable processing of additive manufacturing can allow for the purposeful design of the macrostructure of the final electrodes, resulting in custom-shaped batteries with enhanced performance and advantageous charge times suitable for applications such as small wearable electronics, aviation, or other systems with volume and shape constraints.

Electrochemical Configuration Versatility. This disclosure demonstrates capability with a wide variety of commonly implemented LIB active materials. The chemically benign nature of the synthesis suggests that its formulation is suitable for use with a variety of different LIB configurations such as with solid-state electrolytes and gel-based electrolyte systems. This method can also be used to fabricate electrodes for other electrochemical systems such as supercapacitors, electrolyzers, fuel cells, capacitive deionization cells, gas diffusion electrodes for electroswing adsorption (i.e. separations/carbon capture), and other metal (-ion) battery systems, among other applications.

### Examples

Materials. All chemicals were used without further purification or treatment, unless stated otherwise. Lithium hexafluorophosphate (LiPF₆, 99.99%), diethyl carbonate (DEC, 99%), camphene (95%, MQ 100), toluene (>99.8%), and polystyrene-block-poly(ethylene-ran-butylene)-block-polystyrene binder (SEBS, average M_{w}˜118,000, MQ 100, [S:EB, 29:71 mol/mol]) were obtained from Sigma-Aldrich. The SuperP conductive additive, polyvinylidene fluoride binder (PVDF, >99.5%), LTO (Li₄Ti₅O₁₂, >98%, D_{range} 0.2-10 μm, D₅₀ 0.9-1.8 μm), LCO (LiCoO₂, >98%, D_{range} 0.3-30 μm, D₅₀ 10-14 μm), LFP (carbon coated LiFePO₄, D_{range} 1-15 μm, D₅₀ 2.5-4.5 μm), and NMC811 (LiNi_{0.8}Co_{0.1}Mn_{0.1}O₂, 99%, D_{range} 5-45 μm, D₅₀ 9-15 μm) were acquired from MTI Corporation. N-methyl-2-pyrrolidone (NMP, >99%) was obtained from Tokyo Chemical Industry Co., Ltd. (TCI). 100 μm thick Li foil (99.9%), was purchased from Alfa Aesar. Fluoroethylene Carbonate (FEC, +99%) was obtained from Solvay. Celgard 2400 microporous monolayer membranes (polypropylene, 25 μm) were generously provided by Celgard.

Freestanding Electrode Fabrication. FSE films were manufactured through an altered slurry casting protocol. Camphene (M.P.=51.5° C.) was employed as the liquid solvent system by maintaining temperatures of approximately 65° C. throughout processing. Slurry solutions employed a 3:1 weight ratio of camphene:slurry solids (active material, binder, and conductive additive). The solid composition of the slurries consisted of an 85:10:5 weight ratio of active material:SuperP:SEBS binder for all electrode composites with the exception of the LTO electrodes, which employed an 80:10:10 formulation. Upon the introduction of solids into the liquid camphene, the solutions mixed for 1 hour in a 65° C. water bath.

Slurry solutions were cast utilizing a TMAX JK-TMJ-200 heated film coater with a doctor blade set to a film height of approximately 150 μm. Films were hot-cast onto a polytetrafluoroethylene (Teflon™, 0.001″ thick) substrate and then immediately quenched by moving the sheet onto a chilled stainless steel plate. Once the camphene solidified, films were dried under vacuum for 10 minutes. The resulting films were manually delaminated from the PTFE substrates, resulting in FSE films, and then dried under vacuum overnight to assure the removal of residual camphene. Electrode films were typically cast to an 18″×3″ area.

Control Electrode Fabrication. Foil-cast control electrode films employed an analogous method to the composite electrodes above. Toluene or NMP were employed as casting solvents when using SEBS and PVDF binders, respectively. The solid composition of the slurries consisted of an 85:10:5 weight ratio of active material:Super P:polymer binder for all electrodes with the exception of the LTO electrodes, which employed an 80:10:10 formulation. Slurry solutions were then cast using a doctor blade set to a height of 200 μm onto 12 μm thick aluminum foil at room temperature for cathodes and anode, respectively. Electrode films were dried for two hours at 120° C. and ambient pressure to evaporate the majority of the solvent and then under vacuum to drive off remaining solvent overnight.

Material Characterization. X-ray diffraction patterns were acquired through a Rigaku Miniflex 600 diffractometer utilizing Cu Kα radiation (λ=1.5418 Å) from 5-80° in a continuous scan mode (1° min⁻¹) with a step width of 20=0.02°. Scanning electron micrographs (SEM) were taken using a Thermo Fisher Quanta 650 environmental scanning electron microscope with an applied accelerating voltage of 30 kV. XPS spectra were recorded using a monochromated 120 W Al-Kα1 X-ray source (hv=1486.5 eV). Four-point probe measurements were conducted with a manual four-point resistivity probe (Lucas 5302; Lucas Laboratories).

Electrode Preparation. Circular freestanding and foil-cast control electrodes were punched directly from the electrode films with a TMAX die electrode punch to a diameter of 13 mm and 15 mm for anodes and cathodes, respectively. Thicknesses of the resulting electrodes were measured using an IP65 Digimatic micrometer.

Electrochemical Analysis. Electrochemical properties of the FSE composites were analyzed in half-cell configurations using 2032 coin-type cells versus lithium foil (Alfa Aesar). Full-cell batteries utilizing a LFP cathode and a LTO anode (N:P ratio=1.26:1) were also tested to elucidate the practicality of the composite system. All cells were assembled using a Celgard 2400 polymer membrane and an electrolyte composed of 1M lithium hexafluorophosphate (LiPF₆) in fluoroethylene carbonate (FEC)/diethyl carbonate (DEC) (1:1 by volume) solution. Excess electrolyte was used (>5 drops) to flood the cell and provide sufficient wetting. Cycling performance and cyclic voltammetry (CV) tests were conducted using a multichannel battery test system (BT 2043, Arbin). Electrochemical potential windows were adjusted to the optimal range of each electrode material employed. The electrochemical window for each configuration demonstrated in this manuscript is as follows: 1) LFP vs Li/Li⁺, 2.5 V-4.0 V; 2) LCO vs Li/Li⁺, 3.0 V-4.2 V; 3) NCM811 vs Li/Li⁺, 2.7 V-4.3 V; 4) LTO vs Li/Li⁺, 1.0 V-2.5 V; and 5) LFP vs LTO, 0.9 V-2.6 V. The electrochemical data presented is an average of three identical cells to assure reproducibility in the results.

Chemical Stability Testing. To probe the compatibility of the camphene solvent system with these active materials, X-ray diffraction (XRD) and X-ray photoelectron spectroscopy (XPS) analyses were employed to analyze the chemical status of the active materials before and after camphene exposure. Results from XRD suggest that even excessive soaking of the various active materials in hot liquid camphene for 6 hours did not affect the bulk chemical composition of these active material constituents.

For a finer analysis of chemical compatibility, XPS was employed to determine if changes to the material surfaces occurred due to camphene exposure by comparing pristine electrode materials to the FSE composites. Survey scans of the electrode materials and their respective composites depicted the expected elemental compositions for each active material composition without noticeable contamination. High-resolution region scans of the pristine active materials and the as formed FSE composites indicated no significant chemical change in the active materials. It should be noted that the pristine NCM and LTO materials contained a significant cobalt oxide and titanium oxide, respectively, contamination on the surface. These chemicals are commonly used as precursors for NCM and LTO materials, respectively, and were leftover as residuals from raw material synthesis. Region scans of the FSE composites denote a removal of these contaminants, suggesting that the electrode fabrication process simulated an additional washing step and removed some of the surface level precursor contamination during the composite formation of NCM and LTO. Overall, these results demonstrate that camphene did not detrimentally react with or alter the chemical composition of the active materials in the final composite, confirming the chemically agnostic nature of the fabrication technique.

Electrode Films. LIBs are utilized as energy storage devices for a variety of different applications including laptops, cellphones, power tools, and EVs; thus a variety of different configurations and active materials are employed to meet the unique demands of each application. Accordingly, for demonstration of the applicability of this disclosed electrode manufacturing platform for LIBs, FSEs were fabricated using multiple different active materials, such as LFP, LTO, LCO, and NCM811. While demonstrating the adaptability of this camphene-assisted fabrication process for different active materials, the unique demands of each active material also tested the FSE platform under a diverse set of operating conditions. LFP cathodes are known for their extensive cycle-life (>80% capacity retention @ 1000 cycles) and therefore served as a prime candidate to test long-term stability. The large lithiation potentials of NCM811 probe high voltage stability, and the reactive Ni and Mn constituents elucidate chemical compatibility of camphene with oxidizing materials. LTO tests both the compatibility of the camphene-assisted fabrication route with nanoparticulate materials and the anodic capability of the resulting composites. Additionally, due to the well-studied and stable nature of these materials, analysis of the effects of the FSE architecture could be decoupled from active material degradation during battery cycling.

The chemically agnostic nature of the camphene solvent system allows for FSE films to be synthesized for all of the aforementioned active materials. The mechanical stability of the FSE films is important for their implementation in roll-to-roll processing, as the films will need to be able to flex and bend without fracturing. FIG. 1 depicts the flexibility and mechanical stability of the FSE films upon bending and folding. Traditional foil-cast electrode films using a PVDF binder have limited flexibility as substantial flexing can cause film cracking and delamination, resulting in disconnection of the electroactive layer from the external circuit. In contrast, these FSEs do not demonstrate any fracturing or material loss upon flexing. The FSE films can withstand normal electrode processing and were punched directly from the film using a standard 13 or 15 mm diameter electrode punch. Compatibility with standard processing methods makes this synthesis platform attractive from a manufacturing perspective, as no major changes to the current industrial infrastructure are required for implementation.

After fabrication of FSEs comprised of NCM, LFP, LCO, and LTO, scanning electron microscopy was employed for closer inspection of film homogeneity, material distribution, and camphene-induced pore morphology. Cross-sections of these uncompressed electrodes exhibited a relatively flat and uniform structure. The active materials are anchored in the conductive composite electrode architecture by SEBS polymer coated with SuperP. The casting process results in two different electrode faces, one which was in contact with the Teflon substrate during casting (denoted as the “substrate side”) and one which maintained exposure to vacuum (denoted as “vacuum side”). With the exception of nanoparticulate LTO, where settling effects likely resulted in a denser vacuum side and more porous substrate side, little difference in morphology between the two electrode faces was observed. Compared to traditional NMP foil-cast electrode films, the FSEs demonstrate about a 20% increase in porosity, which can decrease mass transport limitations via enhanced electrolyte penetration.

Electrochemical Activity. Electrochemical activity and performance of the FSE composites were analyzed comparatively using foil-cast electrodes as controls. Two types of controls were utilized for this analysis: foil cast electrodes with lower active mass loading (to verify achievable capacity of active materials) and those with comparable active mass loading (to probe a 1:1 comparison on the electrode level). The morphology and structure of typical foil-cast electrodes are dependent on the settling nature of particles after casting. Due to the intrinsic nature of this morphology, LIB electrodes are often limited to approximately 100-150 μm of electroactive height in order to obtain sufficient lithium storage kinetics and mechanical stability. Therefore, thinly cast electrodes with lower active mass loadings were fabricated to establish a baseline for ideal electrochemical kinetics and performance. On the other hand, for electrode-level analyses the electroactive layer thickness is crucial in drawing fair comparisons; these control electrodes with lower electrochemical active mass loading will inherently demonstrate a larger fraction of inactive electrode mass from the metallic current collector, and electrodes with similar volumetric active material loading (mg/cm³) that have different thicknesses will display different areal capacities. As such, controls were also fabricated with comparable electroactive mass loadings on foil to enable valid quantification of the benefits of the FSE system to enhance the electrode-level performance of LIBs.

As previously mentioned, battery performance without an external CC is contingent upon electrochemical stability, conductivity, and active material accessibility. Before investigating the propensity for Li⁺ storage in these FSE composites, four-point probe analysis was conducted to quantify the bulk conductivity of each respective FSE. The sheet conductivity of all the FSEs were approximately 0.1 S/cm irrespective of active material, which is above the threshold required for high-rate, low overpotential electrochemical cycling. This similarity in conductivity suggested that the electrical conductivity was primarily attributed to the homogenous dispersion of the conductive Super P additive throughout the FSEs. The slight variation in conductivity between FSEs comprised of different active materials points toward the versatility of this camphene-assisted FSE fabrication process for use with diverse materials.

The electrochemical activity of the FSE composites was investigated via cyclic voltammetry in half-cells with a scan rate of 0.1 mV/s in 1M LiPF₆ FEC:DEC electrolyte solution. Upon cycling, the NCM622 FSE displayed peaks between 3.6 and 4.0V, indicative of the expected Ni⁴⁺/Ni³⁺ and Ni³⁺/Ni²⁺ redox reactions. The LFP-, LCO-, and LTO-based composites showed reversible (de)lithiation peaks centered at 3.4, 3.9, and 1.5V, respectively. The slight activation process observed for these materials, where initial cycles required slightly increased overpotential for Li⁺ removal/insertion, was likely related to stabilization of interfaces and/or structural reorganization within these early cycles. Overall, these cyclic voltammetry experiments revealed that the FSE composites displayed very comparable electrochemical behavior to their foil-cast counterparts, demonstrating electrochemical accessibility for Li⁺ storage of the active materials within these composite matrices.

After investigating the potential-dependence of the Li⁺ insertion processes for the various active material composites, variable (dis)charging current densities were applied in half-cells to quantify the rate performance of the FSE electrodes in comparison to conventional foil-cast counterparts. Low-rate (C/20) electrochemical cycling revealed near identical specific capacities between the composite and control electrodes on an active material basis. With the exception of LFP, the FSEs exhibited a slight increase in specific capacity for all of the electrode materials, confirming that the camphene-assisted FSE configuration provides full accessibility of active materials throughout the composite in the absence of ionic transport limitations. In contrast, intentionally introducing transport-induced limitations to the cells via higher-rate cycling (1C) demonstrated the benefits of the conductive and porous FSE architecture, as an improvement in specific capacity was observed for all electrode materials compared to conventional foil-cast counterparts with similar electroactive thicknesses (3 mAh/g for LFP, 4 mAh/g for NCM, 58 mAh/g for LTO, and 25 mAh/g for LCO). As a result, the FSEs demonstrated overall larger rate retention (i.e., percent capacity achieved at 1C compared to the nominal C/20 capacity) of 70.8% vs. 70.3% for NCM, 79.8% vs. 65.3% for LCO, 62.3% vs. 26.6% for LTO, and 74.8% vs. 68.4% for LFP for FSEs vs. foil-cast counterparts, respectively. While the composite architecture clearly does not fully eliminate transport limitations, these current collector-free FSEs exhibited a significant improvement in rate capability as compared to conventional foil-cast cells. Further results of this variable rate testing emphasized the robust nature of the FSEs, which showed exceptional capacity recovery at C/5 for all materials (≥99.0% compared to ≤99.0% for foil-cast controls) after high-rate (de)lithiation.

Battery electrode performance can be limited to factors irrespective of the intrinsic properties of individual active materials, which create parasitic overpotentials related to insufficient electronic conductivity and/or mass transport limitations. Accordingly, charge-discharge curves helped to draw further insight into the rate performance enhancement of the FSEs compared to foil-cast electrodes. In half-cells of these active materials that have well-defined, energetically similar lithiation sites, ohmic overpotentials from ionic or electronic resistivity manifest as the difference in plateau voltage on the charge and discharge branches of the cycle, while concentration overpotentials result in the sloping region at larger specific capacities as the Li⁺ concentration profile becomes the rate-limiting factor for the (de)lithiation process. In a set voltage window, variation in either of these factors will affect the practically achievable Li⁺ storage capacity.

Comparing the voltage gaps between the charge and discharge profiles from cycling at rates of C/10 to 1C demonstrated that the FSEs exhibited lower ohmic overpotentials than their foil-cast counterparts (change in plateau voltage of 30 vs. 60 mV, 80 vs. 170 mV, 100 vs. 150 mV, and 220 vs. 230 mV for FSEs vs. foil-cast controls comprised of LFP, LTO, LCO, and NCM, respectively). As the FSE and the foil-cast cells were fabricated with identical electrolyte formulations (i.e., with identical ionic conductivity), the smaller ohmic overpotentials observed for the FSEs was likely instead related to an enhanced electronic conductivity in the FSEs, despite their larger porosity, compared to their foil-cast counterparts. Coupled with the fact that each set of electrodes was comprised of similar electroactive thicknesses and identical ratios of solid components, these lower observed ohmic overpotentials in the FSEs suggested that the unique camphene-templating process led to the formation of a better-connected conductive, percolating framework of SuperP in contrast to the conventional foil-cast technique, where the resulting morphology relied instead on random particle mixing and settling. Additionally, compared to the discharge curves of foil-cast controls, discharge curves of the FSEs demonstrated larger slopes near full depth of discharge. These increased slopes were indicative of smaller concentration overpotentials and suggest a reduction of mass transport limitations throughout the porous FSE structure compared to the foil-cast control. Overall, these variable rate-cycling results suggested that the FSEs exhibited improved (de)lithiation kinetics due to more efficient transport of both electrons and ions in these porous 3D architectures compared to conventional electrodes, even in the absence of an external current collector and when utilizing thicker electrodes containing higher active mass loadings.

Long-Term Cycling. Constant current C/2 performance testing was employed to investigate long-term stability of the FSEs in lithium-ion half-cells and compare their electrochemical properties to conventional foil-cast systems. Additional testing of foil-cast controls using a traditional NMP solvent and PVDF binder was conducted to mimic commercial electrodes. For further details on control electrode fabrication and composition, please refer to the materials section. Values were calculated for the specific capacity relating to the total amount of active material in the FSE, the gravimetric capacity concerning the entire electrode mass including binder, conductive additive, and CCs, and the areal capacity (capacity provided per unit area cm⁻²).

As the rate-capability of FSEs showed promising results compared to controls, long-term C/2 cycling further demonstrated the potential for the camphene-template system to fabricate stable, high-energy density FSEs with comparable or superior Li⁺ storage ability compared to metal-foil counterparts. All FSEs successfully demonstrated stable galvanostatic lithiation/delithiation for 200 cycles with capacity retention greater than 80%, verifying that the metal foil current collector was not necessary to maintain long-term mechanical stability, as the FSE materials demonstrated long-term capacity retentions that were greater than or equal to the control samples. Specifically, the NCM, LCO, LFP, and LTO FSEs delivered an initial specific capacity of 150 mAh/g, 124 mAh/g, 133 mAh/g, and 121 mAh/g, with a capacity retention of 86.9%, 92.7%, 86.5%, and 99.9% capacity retention at 200 cycles, respectively. On the other hand, the NCM, LCO, LFP, and LTO foil-cast controls provided an initial specific capacity of 148 mAh/g, 128 mAh/g, 129 mAh/g, and 111.6 mAh/g, with a capacity retention of 86.9%, 87.6%, 81.3%, and 82.5%, respectively.

In industrial LIBs, the copper foil and aluminum foil CCs make up approximately 40% and 15% of the electrode mass of the anode and cathode, respectively. Improvement in the achievable specific capacity on an active material basis alongside enhanced long-term stability shows promise for the FSEs to bring about considerable improvements to LIBs on the electrode level due to the concurrent elimination of the dead weight and volume of the metallic current collector. When comparing with metal foil control films of similar areal loading of active material, the overall electrode gravimetric capacity was significantly improved for all active materials investigated here. The NCM, LCO, LFP, and LTO FSEs demonstrated an improvement of 94%, 62%, 98%, and 125% increase in effective capacity, respectively, compared to their foil-cast counterparts due in large part to the elimination of the dense metal foil CCs enabled by the camphene-assisted fabrication procedure. Similar improvements were denoted in the areal capacities of the FSE composites. The NCM, LCO, LFP, and LTO composites provided an areal capacity of 1.27 mAh/cm², 1.22 mA/cm², 1.47 mAh/cm², and 0.84 mAh/cm², providing an improvement of 83%, 88%, 110%, and 39%, respectively, compared to similar-thickness electrodes cast on foil. Electrochemical assessment of the FSE composites confirmed that superior electrochemical kinetics and long-term stability can be achieved from films without metal foil support and higher areal mass loadings using this camphene-assisted fabrication process.

Long-term cycling (1000 cycles) was performed for this FSE to further elucidate any effects the FSE system may have on electrode stability. The LFP FSE's maintain average Coulombic efficiencies of 99.99% respectively over the 1000 cycles. Moreover, the LFP FSE capacity retention was 86.8%. These systems have excellent long-term stability and dramatic increases in the overall gravimetric electrode capacity, suitable for scalable fabrication of higher energy density batteries.

Overall, the half-cell electrochemical performance of the composites demonstrated the material-agnostic capability of the camphene-assisted route to create high energy density FSEs. Variable rate cycling and extensive long-term performance testing of these electrodes suggested that the 3-dimensional, porous structure of the electrodes permitted better rate capability for lithiation and a stable host for long-term cycling.

Full-cell Compatibility Testing. While half-cell performance testing displays exceptional electrochemical activity, lithium-half cells provide the composites with a near-infinite source of lithium during cycling. In contrast, for a real world LIB, depletion of lithium inventory in the cell is one of the most common causes of battery failure and performance degradation over time. Therefore, full-cell configurations were fabricated to elucidate performance metrics of FSEs in a practical LIB.

Due to their long-term stability and single feature voltage profiles, LTO and LFP were chosen as a respective cathode and anode pair. Full cells utilized a N:P ratio of 1.26:1 and underwent constant current-constant voltage (CCCV) formation cycles at C/20 before long-term testing was conducted. Cyclic voltammograms of the LTO/LFP cell suggested that a 0.9-2.6V voltage window was sufficient to achieve 100% depth of (dis)charge upon cycling. Subsequent voltammograms depicted similar performance to the half-cell configurations, where after an initial activation during the 1^{st} cycle, reversible lithiation processes occur.

Overall, the full-cell configuration of these FSEs provided an electrochemical performance that mirrored the individual half-cell counterparts. Even without traditional metal foil current collectors, these systems achieved an initial charge capacity of 120 mAh/g on an active material basis, with a capacity retention of 80.9% and an average Coulombic efficiency of 99.95% after 250 cycles. Furthermore, a quantitative assessment of the system denotes an areal capacity of 0.73 mAh/cm². These results suggest that the camphene-assisted FSEs act as stable hosts for lithium-storage materials even after extensive lithiation/delithiation.

The capacity retention of the FSE full-cells suggested that the electrodes maintained their mechanical integrity even after extensive cycling. For confirmation, cells were disassembled and electrodes were retrieved for post-mortem analysis. These electrodes displayed very little mechanical adherence to the polymer separator, and after simple electrode recovery with forceps, macroscopic visual inspection denoted little to no physical change after cycling. The flexibility of the electrodes, tested after a simple ethanol wash and drying, was nearly identical to pre-cycled FSEs. One of the major bottlenecks to the effective recycling of battery separators is that electrode materials are commonly physically embedded into the separator after extensive cycling. Therefore, these FSEs may provide a route towards more easily recycled materials in LIB systems. Microscopic inspection of the resulting electrodes depict a unique phenomenon. While typical foil-cast electrodes demonstrate a major reduction in distinguishable features post-mortem due to particle pulverization and the formation of interface layers, the FSEs retained a majority of their discernable features. This is likely due to the porous nature of the composites, providing void volume to compensate any volumetric changes induced from lithiation/delithiation. The integrity of physical properties and structural composition elucidates how the full cell composed of a pair of FSEs is able to undergo stable (de)lithiation for more than 250 cycles.

Metal Foil Casting of Electrodes. Camphene-produced porous electrode films on metal foil substrates were manufactured through a heated slurry casting protocol, where camphene (M.P.=51.5° C.) was employed as the liquid solvent system by maintaining temperatures of approximately 65° C. throughout casting. Slurry solutions for metal foil casting were comprised of the same composition as other techniques listed in the examples herein. Upon the introduction of solids into the liquid camphene, the solutions were mixed for 1 hour in a 65° C. water bath. Slurry solutions were cast with a heated doctor blade film coater. Films were effectively cast at heights ranging from 0.05 mm to 2 mm. Films were hot-cast onto a battery-grade aluminum (˜12 μm) or copper (˜8 μm) foil substrate, then the film was immediately quenched by moving the film onto a room temperature-steel plate. Once the camphene solidified, films were dried under vacuum for one hour to fully sublime the camphene. The result was a porous electrode supported on a metal foil substrate, with initial porosities in the range from 40% to 75%. The dried film can be mechanically compressed using calendaring to adjust both the final height and porosity of the film to the desired result. Like the work shown with the free-standing electrodes, camphene provides a chemically agnostic platform for casting metal foil lithium-ion battery electrodes.

Electrochemical testing of these films demonstrates analogous to superior performance to traditional foil cast films without the use of a NMP solvent. Full cell testing (employing both a camphene derived foil cast anode and cathode) showed good results, providing an initial capacity of 122 mAh/g with a capacity retention of 84.2% over 200 cycles.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of making a porous film, the method comprising:
disposing a slurry on a substrate, wherein the slurry comprises an electrochemically active material, an electrically conductive material, and a binder dispersed in an organic sublimable material, wherein the electrochemically active material and the electrically conductive material are different;
solidifying the slurry to yield a film on the substrate; and
subliming the organic sublimable material to yield the porous film on the substrate.

2. The method of claim 1, further comprising reducing a thickness of the porous film.

3. The method of claim 1, wherein, during disposing, a temperature of the slurry exceeds a melting point of the organic sublimable material.

4. The method of claim 1, wherein solidifying the slurry comprises cooling the slurry to a temperature below a melting point of the organic sublimable material.

5. The method of claim 1, further comprising separating the porous film and the substrate.

6. The method of claim 1, wherein disposing comprises slurry casting, mold casting, or additive manufacturing.

7. A slurry comprising:
a solid component comprising:
an electrochemically active material;
an electrically conductive material; and
a binder; and
a liquid component comprising an organic sublimable material,
wherein the electrochemically active material and the electrically conductive material are different, and the solid component is dispersed in the liquid component.

8. The slurry of claim 7, wherein the electrochemically active material comprises one or more of a lithium iron phosphate, a lithium titanium oxide, a nickel cobalt manganese oxide, a lithium cobalt oxide, and a sodium manganese oxide.

9. The slurry of claim 7, wherein the electrochemically active material comprises one or more of a metal alloy, a metal oxide, a chalcogenide, silicon, tin, and an electron-conducting carbon based material;
wherein the electron-conducting carbon based material comprises one or more of graphene, graphite, carbon nanotubes, and porous carbons.

10. The slurry of claim 7, wherein the electrically conductive material comprises one or more of carbon black, carbon nanotubes, graphene oxide, graphene, reduced graphene oxide, and metal nanostructures.

11. The slurry of claim 7, wherein the binder comprises a thermoplastic polymer; wherein the thermoplastic polymer comprises one or more of a styrene-ethylene-butylene-styrene copolymer, a sodium carboxy methyl cellulose, a styrene butyl rubber, a polyvinylidene fluoride, and a polyolefin.

12. The slurry of claim 7, wherein the organic sublimable material comprises one or more of a terpene, naphthalene, anthracene, salicylic acid, benzophenone, pyrene, 1,6-diaminohexane, hexamethylenetetramine; adamantane, 2,4,6-triamino-1,3,5-triazine, and phthalic anhydride.

13. The slurry of claim 12, wherein the terpene comprises one or more of camphene, menthol, borneol, camphor, and pinene.

14. The slurry of claim 7, wherein a weight ratio of the liquid component to the solid component is in a range of about 2:1 to about 4:1.

15. The slurry of claim 7, wherein the solid component comprises:
about 70 wt % to about 90 wt % of the electrochemically active material;
about 5 wt % to about 20 wt % of the electrically conductive material; and
about 1 wt % to about 10 wt % of the binder.

16. The slurry of claim 7, wherein a temperature of the slurry exceeds a melting point of the organic sublimable material.

17. The slurry of claim 7, wherein the slurry is free of N-methyl-2-pyrrolidone.

18. An electrode comprising the porous film of claim 1.

19. The electrode of claim 18, wherein:
the porous film is separated from the substrate; or
the electrode further comprises a metal current collector in contact with a surface of the electrode.

20. A lithium-ion battery comprising the electrode of claim 18.
